(19) United States
(12) Patent Application Publication
(10) Pub. No.: US 2011/0196679 A1
(43) Pub. Date: Aug. 11, 2011

(54) Systems And Methods For Machine To Operator Communications

(75) Inventors: Peter Skalchunes, Clemmons, NC (US); Kay Skalchunes, Clemmons, NC (US)

(73) Assignee: Essex Incorporated, Winston-Salem, NC (US)

(21) Appl. No.: 12/942,304

(22) Filed: Nov. 9, 2010

Related U.S. Application Data
(60) Provisional application No. 61/259,415, filed on Nov. 9, 2009.

(51) Int. Cl. H04W 88/02; G10L 13/08

(52) U.S. Cl. 704/260; 455/91; 455/73; 704/E13.011

(57) ABSTRACT

Systems and methods for machine to operator communications are disclosed. For example, one disclosed system includes a concentrator having a memory; a radio transmitter; and a processor in communication with the memory and the radio transmitter, the processor configured to: request information associated with a status of a machine; receive information associated with the request; determine a message based on the received information; generate an audio signal based on the message; and transmit the audio signal to the radio transmitter.

### CROSS-REFERENCE TO RELATED APPLICATIONS

This patent application claims priority to U.S. Provisional Patent Application No. 61/259,415, filed Nov. 9, 2009, entitled “Systems and Methods for Machine to Operator Communications,” the entirety of which is hereby incorporated by reference.

### BACKGROUND

In facilities operating multiple large industrial machines, such as in a carpet manufacturing plant, one or more operators may be assigned to each machine to ensure the machine operates correctly and to correct errors quickly and efficiently as they occur. Typically, machine errors are indicated using primitive equipment, such as one or more lights mounted on the machine. For example, a carpet tufting machine may have a stack of lights mounted at or near the top of the machine. Each colored light may indicate a status of the machine. An operator monitoring the machine may see a red-colored light, which indicates an error or failure of the machine, and then may take necessary corrective action.

However, such light stacks may be imprecise and may not be ideal status indicators. For example, a red light may indicate the machine has stopped operating due to an error, but the operator receives no additional information to indicate the type of error that occurred, or where in the machine the error occurred. Thus, the operator must spend time diagnosing the problem. Further, because the indication mechanism is a light, if the operator does not have line-of-sight to the light, or if the operator simply does not check the light, an error condition may go unnoticed for an extended period of time. This may occur if one operator is responsible for operating multiple machines, particularly if the machines are very large and located across a large area of a manufacturing plant.

### SUMMARY

Embodiments of the present invention provide systems and methods for kinesthetic rotational feedback in a handheld device. For example, in one embodiment, a system includes a concentrator comprising: a memory; a radio transmitter; a processor in communication with the memory and the radio transmitter, the processor configured to: request information associated with a status of a machine; receive information associated with the request; determine a message based on the received information; generate an audio signal based on the message; and transmit the audio signal to the radio transmitter.

In one embodiment of a method, the method comprises requesting information associated with a status of a machine; receiving information in response to the request; determining a message based at least in part on the received information; generating an audio signal based at least in part on the message; and transmitting the audio signal to a radio transmitter. In another embodiment, a computer-readable medium comprises program code for causing a processor to execute such a method.

These illustrative embodiments are mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

Features, aspects, and advantages of the present invention are better understood when the following Detailed Description is read with reference to the accompanying drawings, wherein:

FIGS. 1-3 show systems for machine to operator communications according to one embodiment of the present invention; and

FIG. 4 shows a method for machine to operator communications according to one embodiment of the present invention.

### DETAILED DESCRIPTION

Embodiments of the present invention provide systems and methods for machine to operator communications.

### Illustrative Machine to Operator Communications

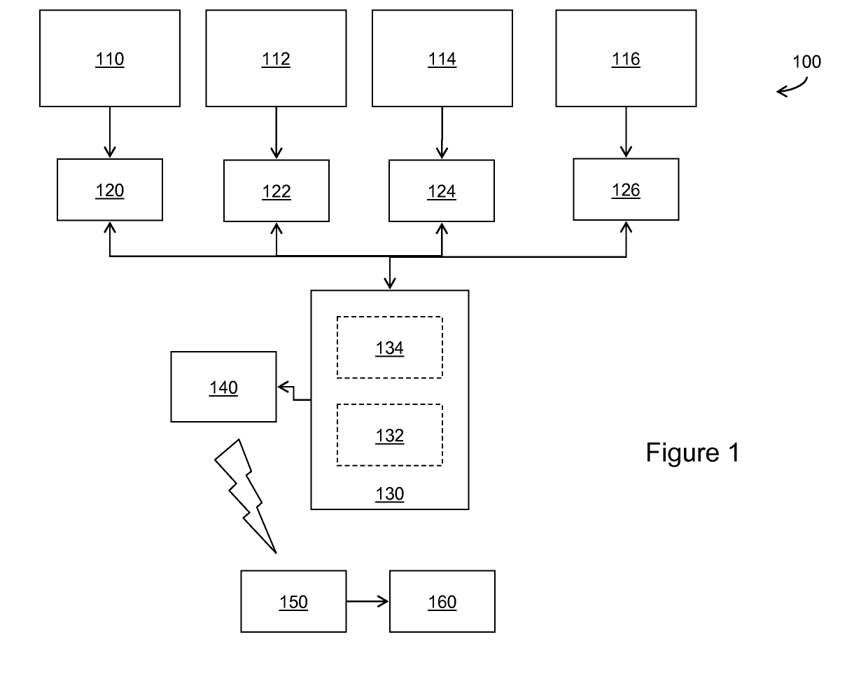

Referring now to FIG. 1, FIG. 1 shows an illustrative system 100 for machine to operator communications according to one embodiment of the present invention. In the illustrative embodiment shown in FIG. 1, the system 100 for machine to operator communications comprises four carpet tufting machines 110-116, four controllers 120-126, a concentrator 130 comprising a processor 132 and memory 134, a radio transmitter 140, a radio receiver 150 and a speaker 160. The system 100 is configured to receive messages from the one or more machines 110-116 at their respective controller 120-126 and translate the messages into a format recognizable by the concentrator 130. The concentrator 130 is configured to request information from each of the controllers 120-126 and to receive information from the controllers 120-126 based on the translated messages. The concentrator 130 is then configured to identify textual messages associated with received information, and convert the textual messages to audio signals. The concentrator 130 is further configured to transmit the audio signals to the radio transmitter, which is configured to transmit the audio message to the radio receiver, which outputs the audio message to the speaker for an operator to hear. Thus, using this illustrative embodiment, it may be possible for an operator to monitor several tufting machines 110-116 by hearing audible messages that provide detailed information about errors that have occurred within one or more of the machines 110-116.

This illustrative embodiment may provide sufficient information to significantly reduce or eliminate time that might ordinarily be spent by the operator to diagnose the problem. Further, because the operator receives an audible message from the concentrator 130, the operator does not need to actively poll the multiple machines for error conditions. In a large facility with several machines it may not be possible to see error lights on machines from a single location. Thus, as the operator performs rounds through the machines, an error may occur in a machine and it may take several minutes until the operator returns to check the machine again to discover the error. This illustrative embodiment shows that it may be possible to consolidate error reporting to a central location and to provide real-time, or near real-time, reporting of error conditions to an operator. Further, because an operator likely will need to spend less time diagnosing errors, the operator's productivity may be increased and thus allow a facility to operate and maintain a greater machine-to-operator ratio.

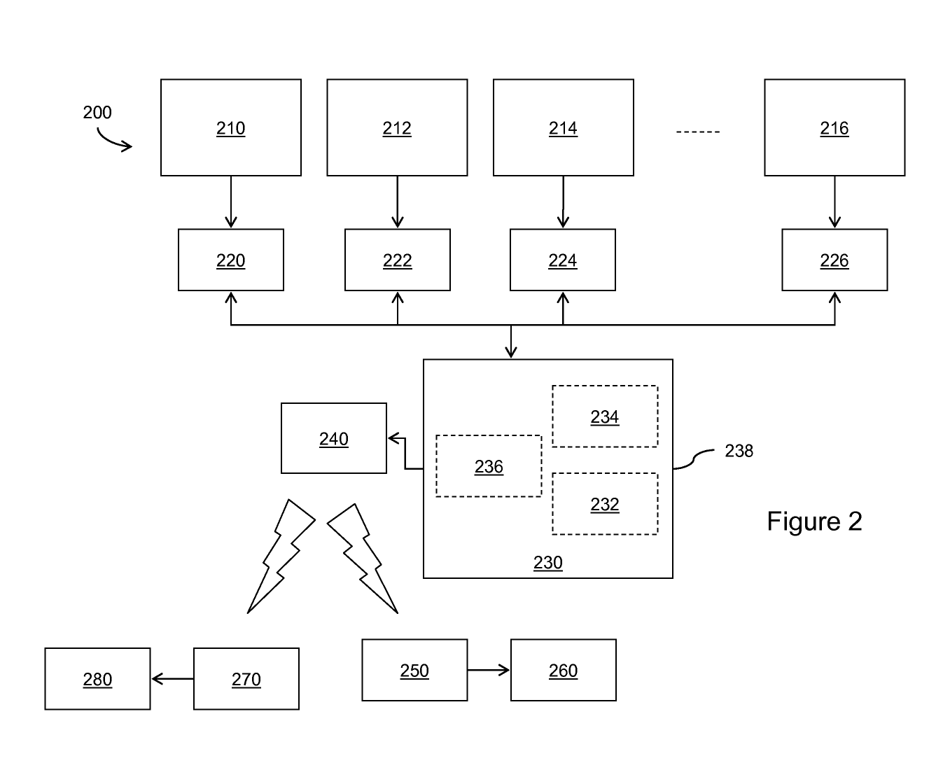

Referring now to FIG. 2, FIG. 2 shows a system 200 for machine to operator communication according to an embodiment of the present invention. In the embodiment shown, the system 200 comprises a plurality of machines 210-216. The embodiment shown comprises at least 4 machines, though some embodiments may comprises fewer than four machines or greater than four machines. For example, one embodiment may comprise only one machine, or may comprise two machines. Each machine is in communication with a respective controller 220-226. In the embodiment shown, each machine 210-216 is in communication with its own unique controller 220-226; however, in some embodiments, a plurality of machines may share a controller 220-226. For example, in one embodiment, up to four machines may share a controller 220-226.

The system 200 further comprises a concentrator 230. The concentrator 230 is in communication with a radio transmitter 240. Radio transmitter 240 is configured to transmit radio signals to one or more radio transceivers 250, 270. The radio transceivers 250, 270 are in communication with speakers and microphones 260, 280 for outputting audible messages and receiving audible input.

In the embodiment shown in FIG. 2, each of the controller 220-226 is in communication with a concentrator 230. In the embodiment shown, the system 200 comprises only a single concentrator 230; however in some embodiments a plurality of concentrators 230 may be employed. In system 200, the concentrator comprises a housing 238 in which are disposed a processor 232, a memory 234, and a programmable logic controller (PLC) 236. The processor 232 is in communication with the memory 234 and the PLC 236. The processor 232 is configured to execute program code stored in memory 234. Memory 234 comprises at least one form of computer-readable media and may comprise multiple computer-readable media. For example, in the embodiment shown in FIGS. 1 and 2, memory 234 comprises a flash drive for file storage and DRAM for processor execution instructions and data. The PLC 236 is configured to provide additional functionality to the processor. For example, in the embodiment shown in FIG. 2, PLC 236 is configured to receive signals from the processor 232 and to activate or deactivate the transmit functionality of the radio transmitter 240 based at least in part on the signals received from the processor 232 or to command the radio transmitter to change to a different radio frequency.

In the embodiment shown in FIG. 2, the concentrator 230 is in communication with the controllers 220-226 using RS-422 serial communications. However, in other embodiments, other communication methods may be used, such as other serial connections (e.g. RS-232, USB, etc.), wired networking connections (e.g. Ethernet), or wireless connections (e.g. 802.11, 802.15, Bluetooth, etc.).

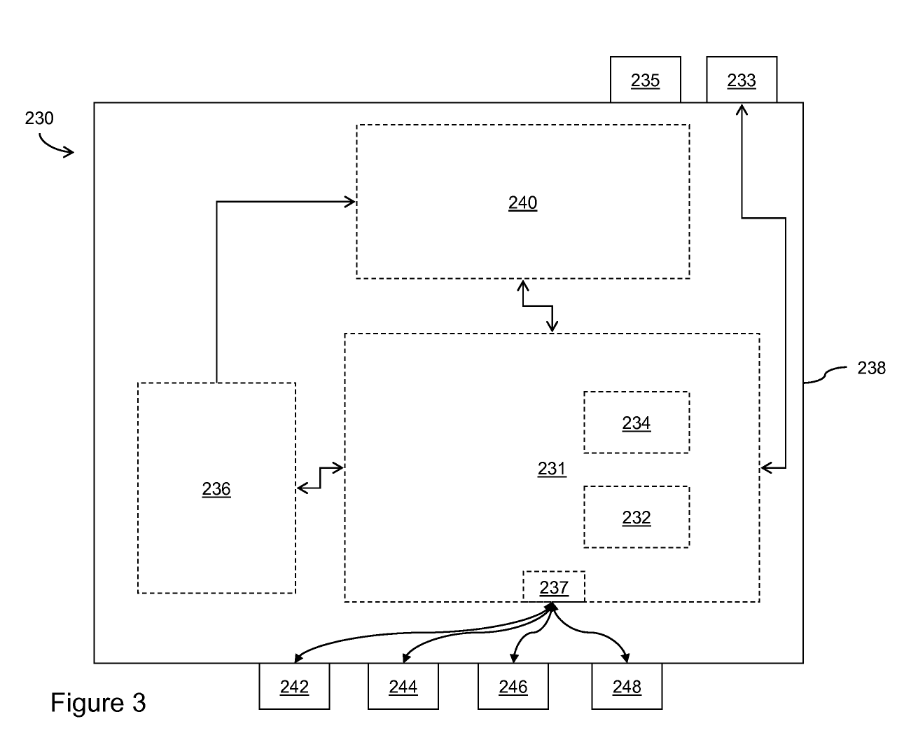

Referring now to FIG. 3, FIG. 3 shows a more detailed view of a concentrator 230. In the embodiment shown in FIG. 3, the concentrator 230 comprises a housing 238 having four ports 242-248 housing connections between the processor 232 and one or more controller 220-226. In the embodiment shown, ports 242-248 are configured to receive CAT-5 cables terminated with RJ-45 connectors for RS-422 serial communications. In other embodiments, the ports 242-248 may comprise different connectors or concentrator 230 may have a greater or fewer number of ports 242-248. In addition, housing 238 includes a switch 233 for selecting a language for audio messages and a power switch 235. Disposed within the housing are a single-board computer 231 having a processor 232, memory 234 comprising DRAM and a flash drive, and an RS-232 serial port (including an RS-422 to RS-232 converter). Single board computer 231 provides communications between the processor 232 and PLC 236 and radio transmitter 240. In addition, PLC 236 is in communication with radio transmitter 240.

In some embodiments, concentrator 238 may also comprise one or more chargers (not shown) for radio transceivers 250, 270 carried by operators or supervisors.

In the embodiment shown in FIG. 2, the processor 232 is configured to request information from the controllers 220-226, to receive information from the controllers 220-226, and to determine one or more audio messages to be generated based at least in part on the information received from the controllers 220-226. The processor 232 is further configured to generate an audio signal, transmit a signal to the PLC 236 to cause the PLC 236 to activate the radio transmitter 240, transmit an audio signal to the radio transmitter 240, and to transmit a second signal to the PLC 236 to cause the PLC 236 to deactivate the radio transmitter 240.

To request information from the controllers 220-226, in this embodiment, the processor 232 is configured to transmit a signal to one of the controllers 220-226. In response, the controller 220-226 transmits a signal to the processor 232 comprising information associated with request received from the processor 232. For example, in one embodiment, controller 220 is configured to maintain data indicating the existence of one or more error conditions. In this embodiment, the controller 220-226 maintains three 16-bit data fields, the first data field indicating thread breakages and the location of the breakage, the second data field indicating tight ends and the location of the tight end, and the third data field indicating status information, such as completion of a carpet roll, carpet backing status, safety warnings, etc. The data fields, in this embodiment, comprise bit fields wherein each bit position represents a location within the machine 210-216. Thus, because the bit field represents thread breakages, the combination of one or more of the bits being set within the bit field indicates a thread breakage at the location corresponding to the set bit(s). In other embodiments, error or status information may be represented in other ways. For example, error or status codes may be generated according to a table of values, or message may comprise multiple parts, including an error or status type, a location, a duration of the error or status, or other parameters associated with the error or status information. In some embodiments, the error or status messages may comprise textual information, such as textual descriptions of errors or status conditions.

In response to a request from the processor 232, the controller 220-226 is configured to transmit information from one or more of the data fields to the processor 232. For example, in the embodiment shown in FIG. 2, the processor 232 sends a request for thread breakage errors to controller 220. In response, the controller 220 transmits information comprising the first data field to the processor 232. The processor 232 receives the information from the controller 220 and determines one or more audio messages to be generated based on the information received from the controller 220, such as based on bits that are set within the bit field.

In the embodiment shown in FIG. 2, memory 234 comprises at least one file comprising an error message in a text format. In this embodiment, the at least one file comprises a text file in ASCII format, though in other embodiments, the file may comprise different formats. For example, in one embodiment, the file may be a file in an audio format or in a compressed format. In some embodiments, the text file may be dynamically generated based at least in part on the information received from the controller 220. In some embodiments, a file may not be used at all. In the embodiment shown in FIG. 2, the text files are stored in one or more directories within memory 234. Further, text files may comprise messages in one or more languages. In one such embodiment, error messages in a plurality of languages, including English and Spanish, are stored in different directories within the memory 234 and may be selected based on a language setting.

After receiving the information from the controller, the processor 232 is configured to generate an audio signal based at least in part on the information. For example, in the embodiment shown in FIG. 2, the processor 232 identifies one of the at least one text files stored in memory 234 based at least in part on the information received from the controller 220. The processor 232 performs text-to-speech conversion to generate an audio signal. In one embodiment, different speech parameters are used based on the controller 220-226 from which the information was received. Such an embodiment may provide an audible indication of the machine associated with the audio message. For example, the processor 232 may generate speech from text with a high-pitched voice for information received from machine 220 and may generate speech using a low pitched voice for information received from machine 222. In further embodiments, speech may be generated with male or female characteristics or with different accents.

The processor 232 is configured to transmit the generated audio signal to the radio transmitter 240. In the embodiment shown, before transmitting the generated audio signal to the radio transmitter 240, the processor 232 transmits a signal to the PLC 236 to cause the PLC 236 to activate the radio transmitter 240. After the processor has transmitted the audio signal to the radio transmitter, the processor 232 transmits a second signal to the PLC 236 to cause the PLC to deactivate the radio transmitter 240. In some embodiments, however, the radio transmitter 240 may be permanently activated. In such an embodiment, the processor 232 simply transmits a generated audio signal without first sending a signal to the PLC 236 to activate the radio transmitter 240.

In some embodiments, the concentrator 230 may be configured to provide audio notifications to the operators' supervisor(s). For example, in one embodiment, the radio transmitter 240 may be configured to transmit on one of a plurality of selectable radio frequencies. In such an embodiment, a first frequency may correspond with radio receivers 250 carried by one or more operators and a second frequency may correspond with radio receivers 270 carried by one or more supervisors. The processor 232 in one such embodiment is configured to transmit a frequency signal to the PLC 236 which is configured to indicate a radio frequency to select. For example, the processor 232 may transmit a signal to the PLC 236 to indicate that a radio frequency associated with one or more operators is selected, or the processor 232 may transmit a signal to the PLC 236 to indicate that a radio frequency associated with one or more supervisors is selected. Thus, the processor 232 may be able to select the radio frequency on which to send the audio signal.

In such an embodiment, the processor 232 is configured to transmit an audio signal indicating an error or status condition to the operators periodically, such as every 10 seconds. The processor 232 is further configured to send an audio signal to a supervisor using a different radio frequency if the error or status condition persists for an extended period of time, such as for greater than 5 minutes. For example, in the embodiment shown in FIG. 2, radio transceiver 270 is carried by a supervisor and a plurality of radio transceivers 250 are carried by a plurality of operators. The concentrator 230 is configured to generate and transmit audio signals to the operators every 10 seconds if a condition is detected that results in an audio message. If the condition is not addressed within 5 minutes, the concentrator 230 continues to send audio signals to the operators' radio transceivers 250, but the processor 232 will also send a signal to the PLC 236 to cause the radio transmitter to switch to a radio frequency associated with the supervisor's radio transceiver 270. The processor 232 will then generate and transmit an audio signal to the radio transmitter 240, which transmits the audio signal to the supervisor's radio transceiver 270. In one such embodiment, the audio message may comprise information describing the error (e.g. “Machine 1, Thread Break, Zone 1”) as well as a duration of the error condition (e.g. “Machine 1 has been offline for 5 minutes”). Further, in some embodiments, the audio message may provide information regarding the radio frequency of the operators responsible for addressing the condition (e.g. “Channel 2”). Thus, in such an embodiment, a supervisor may receive an audio message indicating an error condition for a machine, the time the machine has been down or non-operational, and which radio channel to use to contact the operators responsible for resolving the error.

In the embodiment shown in FIG. 2, the radio transmitter 240 is configured to receive audio signals from the processor 232 and to transmit the audio signals. Radio transmitter is activated based on a received signal from the PLC 236, which indicates that the radio transmitter 240 should begin transmitting. The processor 232 then transmits the audio signal to the radio transmitter 240. Once the audio signal has been completely transmitted, the processor 232 transmits a signal to the PLC 236 to cause the PLC 236 to deactivate the radio transmitter 240. Thus, in the embodiment shown in FIG. 2, the radio transmitter 240 is only activated approximately long enough to fully transmit the audio signal. This may allow other uses of the radio channel used by the radio transmitter 240. For example, if a plurality of operators are using radio transceivers, the operators may be able to communicate using their respective transceivers after the radio transmitter 240 has completed transmitting the audio signal, such as to coordinate a solution to an error.

Referring again to FIG. 2, in one embodiment, the controllers 220-226 comprises a programmable logic controller (PLC; not shown), such as an Omron CPM2B PLC. The PLC executes program code for receiving and translating messages from one or more machines 210-216 in communication with the PLC. In this embodiment, the machines 220-226 comprise carpet tufting machines, however, in other embodiments, other types of machines capable of transmitting status or error messages may be used. In one embodiment, a machine may transmit a message to the PLC indicating new status information is available and the PLC may send a request for the status information. In such an embodiment, PLC may ignore some types of status information and only retrieve error information from the machine. In another embodiment, the concentrator 230 may comprise the PLC, or the concentrator 230 may directly receive the message from the machines.

When a controller 220-226 receives a message from the machine, it is configured to translate the message into a data format useable by the concentrator 230. For example, a message from machine 210 may comprise both status information and other information that may not be necessary to pass along to an operator or supervisor. Thus, the controller is configured to extract relevant information from the message received from a machine and generate a translated message to transmit to the concentrator.

For example, in one embodiment, a controller 220-226 receives messages from a machine 210-216 and generates a plurality of 16-bit data words based on the messages received from the machine 210-216. In the embodiment shown in FIG. 2, the data words comprise the following formats:

Data Word 1: Thread Breakage (Zones 1-16)

Data Word 2: Tight End (Zones 1-16)

Data Word 3: Status Conditions

In such an embodiment, each of the bit positions in data words 1 and 2 correspond to a different machine location. Thus, setting bit 4 in data word 1 indicates a thread breakage in zone 5 (i.e. the least significant bit, bit 0, corresponds to zone 1). Thus, if thread breakages have occurred in multiple zones, multiple bits in data word 1 may be set. Similarly, if a tight end occurs, the bit in data word 2 corresponding to the zone location of the tight end is set. As with data word 1, multiple bits within data word 2 may be set to indicate a plurality of tight ends. Once the thread breakage or tight end has been corrected, the corresponding data bit is cleared once new information is received from the machine.

In the embodiment shown in FIG. 2, data word 3 also comprises a bit field, however, each bit corresponds to one of several different status conditions. The following is a mapping of the bit field in data word 3 for this embodiment:

Bit 0: Roll Complete

Bit 1: Backing Change Needed (low priority)

Bit 2: Backing Change Needed (high priority)

Bit 3: Backing Change Needed (machine stopped)

Bit 4: Operator Proximity Safety Warning

Bit 5: Operator Proximity Safety Warning (machine stopped)

Bit 6: Backing Position System overrun

Bit 7: Camera Inspection System message

Bit 8: Safety system bypass warning

Bit 9: Yarn Break

Bit 10: Backing “Run Out” Sensor

Bit 11: Machine stopped (unspecified error)

Bits 12-15: Unused

In the embodiment shown in FIG. 2, each machine 210-216 has its own dedicated controller 220-226. However, in some embodiments, one controller 220-226 may be shared by several machines. In such an embodiment, status or error information may be stored in a plurality of bit fields dedicated to each machine associated with the controller 220-226. In other embodiments, error or status information for multiple machines may be tracked in other ways apparent to one of skill in the art.

For example, in one embodiment, a controller generates data comprising a plurality of parameters, including a status parameter, a machine parameter, and a location parameter. In such an embodiment, the status parameter indicates a status or error condition and comprises a numerical code identifying one of a set of pre-defined status and error conditions. The machine parameter in such an embodiment comprises a parameter identifying the machine that generated the status or error message. For example, the machine parameter may comprise a numerical designation assigned to the machine. In this embodiment, the location parameter indicates a part of the machine associated with the status or error. For example, the location parameter may comprise a number identifying one of a set of pre-defined zones within the machine. In another embodiment, the location parameter comprises a number that identifies a component within the machine. In other embodiments, parameters may comprise textual or additional data fields. For example, in one embodiment, a status parameter may comprise diagnostic data received from the machine, such as detailed status information.

In the embodiment shown in FIG. 2, the operator headset comprises one or more speakers and is configured to receive audio data from the receiver and to output the audio using the speakers. For example, in this embodiment, the operator headset includes a speaker/microphone configured to be clipped to the operator's clothing, such as to a belt or to the operator's collar. Thus, the operator can receive a spoken description of a machine's status or error condition shortly after the machine provides a notification of the status or error. This may allow the operator to respond quickly to new error conditions without needing to notice a change in a light color on a light stack or without needing to monitor a computer workstation.

In one embodiment, the radio transmitter may comprise a radio transceiver and the operator's radio receiver may also comprise a radio transceiver. In such an embodiment, the operator may be able to transmit messages to the computer or to other operators or a supervisor. For example, in one embodiment, the operator can press a button to acknowledge receipt of a message. In another embodiment, the operator can press a button to acknowledge receipt of a message and to delay a reminder for a period of time, such as a few minutes. Such a feature may allow an operator to work on one problem without being continuously reminded of another problem, possibly distracting the operator.

Further embodiments of the present invention may comprise a plurality of radio receivers in communication with one radio transmitter. For example, in one embodiment, a plurality of operators may be responsible for a number of machines in communication with a single controller. In such an embodiment, each operator may be assigned to one or more machines and only receives messages relevant to his assigned machine. In a related embodiment, each operator may have the language of the audio messages set to his own native language.

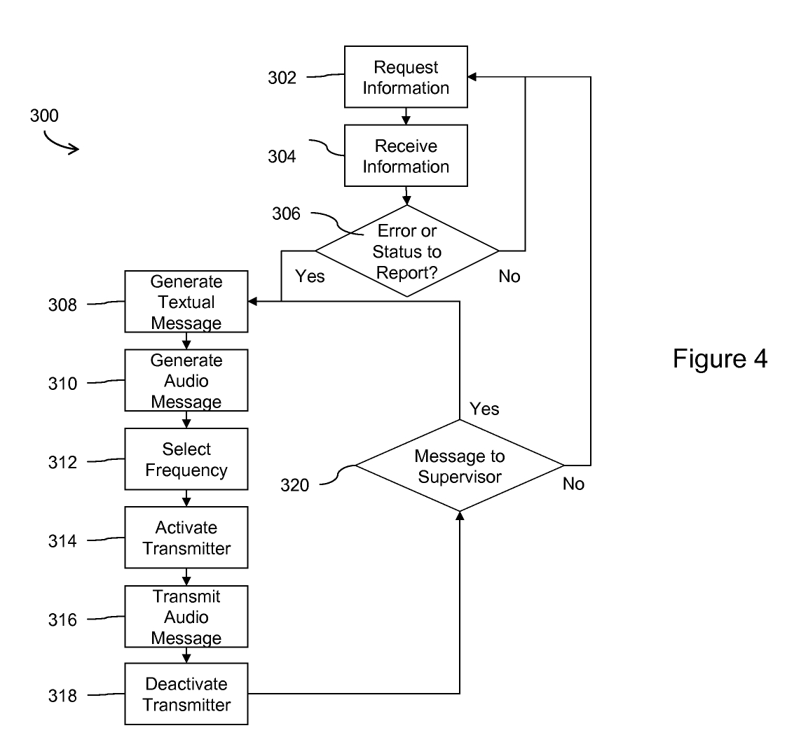

Referring now to FIG. 4, FIG. 4 shows a method 300 for machine to operator communications according to one embodiment of the present invention. The method 300 shown in FIG. 4 will be described with respect to the system shown in FIGS. 2 and 3.

The method 300 begins in step 302 when the concentrator 230 transmits a signal to request information from a controller 220-226. In this embodiment, the concentrator selects one of the RS-422 serial communication lines 242-244 and transmits a requests message using the selected RS-422 line. In an embodiment where the concentrator 230 is in communication with one or more controllers 220-226 using a different communication mechanism, such as Ethernet, the concentrator 230 may specify the address of the desired controller 220-226 in the request message. In a further embodiment, the concentrator 230 may transmit a single broadcast message to all controllers 220-226. Upon receiving a request message from the concentrator, the controller (or controllers) 220-226 transmit a response message comprising information associated with an error or status condition within the controller's respective machine or machines.

In step 304, the concentrator 230 receives the response message from the controller or controllers 220-226. For example, the concentrator 230 may receive data over an RS-422 serial connection from a controller 220-226. The controller 230 may perform error checking to determine whether the message was received correctly, and request a re-transmission if the message was corrupted. After the controller 230 has successfully received the message from the controller, the method proceeds to step 208.

In step 306, the concentrator 230 determines whether any error or status conditions need to be reported to an operator or a supervisor. For example, if a status condition with a low priority occurs, the message may not be sent immediately or at all. If no message is needed, the method returns to step 302. Otherwise, the method proceeds to step 308.

After determining that an error or status condition is to be reported, the method proceeds to step 308. In step 308, the concentrator 230 generates or selects a textual message based on the received information. In the embodiment shown in FIG. 4, the processor 232 selects a message in a text file stored within memory 234. The processor 232 maintains a mapping of error and status conditions to the plurality of text files and thus may select the corresponding text file. In this embodiment, the processor 232 further selects a text message based on a selected language. For example, in the embodiment shown in FIGS. 2 and 3, the concentrator comprises a language select switch 233 that allows either English or Spanish to be selected. In such an embodiment, a plurality of pre-generated English and Spanish text files reside in different directors in memory 234. Depending on the selected language, text files from the appropriate directory are selected.

In some embodiments, additional or different languages may be selected. In some embodiments, a configuration file may indicate which languages are available. Further, while the embodiment shown in FIGS. 2 and 3 allows a selection of a language, it is applied to all messages transmitted by the concentrator. In some embodiments, the language may be selected on a per-machine 210-216 basis, or on an operator/supervisor basis. In still further embodiments, the language may be selected according to other criteria.

In some embodiments, the processor 232 may generate a text message on-the-fly. For example, rather than a directory having a plurality of pre-defined messages, the processor 232 may have access to individual text strings representing one or more words that may be concatenated together to create a text message. In some embodiments, no text message may be created. For example, the processor may receive textual information from a controller 220-226 as a part of a message. In some embodiments, rather than text files, memory 234 may comprise a plurality of pre-recorded audio files that may be selected. After completing step 308, if needed, the method proceeds to step 310.

In step 310, the concentrator 230 generates an audio signal based on the textual message. For example, in the embodiment shown the concentrator 230 executes a text-to-speech converter to generate an audio signal based on the textual message. In another embodiment, the system may generate an audio signal without generating speech from a text message, such as by selecting a pre-recorded audio file or by combining a plurality pre-recorded audio files. After the audio signal has been generated, the method proceeds to step 312.

In step 312, the appropriate radio frequency is selected. In the embodiment shown in FIG. 2, the processor 232 transmits a signal to the PLC 236 to cause the PLC 236 to select a radio frequency on the radio transmitter 240 associated with a radio frequency used by a radio receiver or transceiver 250 carried by an operator. In one embodiment, a plurality of operators may each carry a radio receiver or transceiver 250, some or all of which use a different radio frequency. In such an embodiment, the processor 232 selects a radio frequency based on the machine 210-216 associated with the text message or audio signal to be transmitted. In an embodiment, the processor 232 may select a radio frequency based on whether the audio message is to be sent to an operator or to a supervisor. For example, some messages may only be sent to a supervisor. In such an embodiment, in step 312, the processor 232 may select a radio frequency associated with a supervisor. In an embodiment have a plurality of supervisors, each assigned to one or more radio frequencies, the processor 232 may select a radio frequency based on additional information, such as the machine 210-216 associated with the audio signal or the text message, the error or status to be transmitted, or other parameters. However, in some embodiments, the radio frequency may be fixed and not selectable. In such embodiments, the method may not comprise step 312. After selecting a radio frequency, the processor 232 transmits a signal to the PLC 236 to cause the PLC 236 to configure the radio transmitter to use the selected radio frequency. The method then proceeds to step 314.

In step 314, the processor 232 transmits a signal to the PLC 236 to cause the PLC 236 to activate the radio transmitter. In the embodiment shown in FIG. 4, the PLC 236 receives the signal from the processor 232 and generates a signal to cause the radio transmitter to begin transmitting on the selected radio frequency. In some embodiments, the processor 232 may send a signal to the radio transmitter 240 rather than the PLC 236. For example, in one embodiment, the processor 232 may be in communication with output ports, such as general purpose IO or TTL-style outputs, to provide a signal to the radio transmitter without a PLC 236. However, in some embodiments, the radio transmitter 240 may be permanently activated. In such embodiments, step 314 may not be performed. After the radio transmitter is activated, the method proceeds to step 316.

In step 316, the processor 232 transmits the audio signal to the radio transmitter 240, which encodes the audio signal on a radio transmission. In the embodiment shown in FIG. 2, the processor is in communication with the radio transmitter 240 using a standard audio port. After transmitting the audio signal to the radio transmitter 240, the method then proceeds to step 318.

After the audio message has been transmitted in step 316, the method executes step 318 where the radio transmitter is deactivated. Similar to step 314, the processor transmits a signal to the PLC 236 to cause the PLC 236 to deactivate the radio transmitter 240. In some embodiments, the processor 232 may deactivate the radio transmitter without the use of the PLC 236. Further, as discussed previously, in some embodiments, the radio transmitter 240 may be permanently activated. In such embodiments, step 316 is not performed.

After the radio transmitter 240 has been deactivated, the method proceeds to step 320. As discussed above, in some embodiments, an audio signal may be transmitted to a supervisor if an error or status condition has persisted for an extended period of time or in other circumstances. In step 320, the processor 232 determines whether an audio message is to be generated and transmitted to a supervisor. For example, if an error or status condition has persisted for more than 5 minutes (or every 5 minutes after the initial supervisory notification), the processor 232 determines that a message should be sent to a supervisor. If the processor 232 determines that a message is to be transmitted to a supervisory, the method returns to step 308 to generate a new message, select a radio frequency associated with the appropriate supervisor and transmit the message to the supervisor. If the processor 232 determines that no message needs to be sent, then the method returns to step 302 and the method restarts.

Embodiments of methods disclosed herein are exemplary, including the ordering of the steps. In some embodiments, the steps may be ordered differently. For example, steps 308 and 310 need not be performed before steps 312 or 314. Similarly step 320 may be executed before any or all of steps 308-318. Thus, embodiments may perform machine to operator communications according to specifics of particular embodiments or according to needs in a particular environment.

While the methods and systems herein are described in terms of software executing on various machines, the methods and systems may also be implemented as specifically-configured hardware, such a field-programmable gate array (FPGA) specifically to execute the various methods. For example, referring again to FIGS. 1 and 2, embodiments can be implemented in digital electronic circuitry, or in computer hardware, firmware, software, or in combination of them. In one embodiment, a computer may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

### GENERAL

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

That which is claimed is:

1. A concentrator comprising:
a memory;
a radio transmitter;
a processor in communication with the memory and the radio transmitter, the processor configured to:
request information associated with a status of a machine;
receive information associated with the request;
determine a message based on the received information;
generate an audio signal based on the message; and
transmit the audio signal to the radio transmitter.

2. The concentrator of claim 1, wherein the wherein the processor is further configured to activate the radio transceiver and to deactivate the radio transceiver.

3. The concentrator of claim 2, further comprising a programmable logic controller in communication with the processor and the radio transmitter, and wherein the processor is configured to:
activate the radio transmitter by transmitting a first signal to the programmable logic controller to cause the programmable logic controller to activate the radio, and
deactivate the radio transmitter by transmitting a second signal to the programmable logic controller to cause the programmable logic controller to deactivate the radio.

4. The concentrator of claim 1, wherein the wherein the processor is further configured to select a first frequency or a second frequency on the radio transmitter.

5. The concentrator of claim 4, further comprising a programmable logic controller in communication with the processor and the radio transmitter, and wherein the processor is configured to:
select the first frequency on the radio transmitter by transmitting a first signal to the programmable logic controller to cause the programmable logic controller to select the first frequency on the radio transmitter, and
select the second frequency on the radio transmitter by transmitting a second signal to the programmable logic controller to cause the programmable logic controller to select the second frequency on the radio transmitter.

6. The concentrator of claim 1, wherein the processor is further configured to generate a textual message based on the received information, and to generate the audio message based at least in part on the textual message.

7. The concentrator of claim 6, wherein the processor is configured to perform text-to-speech conversion to generate the audio message.

8. The concentrator of claim 1, wherein the processor is further configured to receive a language signal indicating a language and to determine the message based at least in part on the language signal.

9. The concentrator of claim 1, wherein the processor is further configured to:
determine whether to transmit a message to a supervisor;
determine a supervisor message;
generate a supervisor audio signal based at least in part on the supervisor message; and
transmit the supervisor audio signal to the radio transmitter.

10. A method comprising:
requesting information associated with a status of a machine;
receiving information in response to the request;
determining a message based at least in part on the received information;
generating an audio signal based at least in part on the message; and
transmitting the audio signal to a radio transmitter.

11. The method of claim 10, further comprising generating a textual message and wherein generating the audio signal comprises performing text-to-speech conversion of the textual message.

12. The method of claim 10, further comprising selecting a radio frequency based at least in part on the message.

13. The method of claim 10, further comprising:
activating the radio transmitter before transmitting the audio signal to the radio transmitter, and
deactivating the radio transmitter after transmitting the audio signal to the radio transmitter.

14. The method of claim 10, further comprising determining whether to transmit a notification to a supervisor; and if the notification is to be transmitted to the supervisor:
determining a supervisor message;
generating a supervisor audio signal based at least in part on the supervisor message;
transmitting the supervisor audio signal to the radio transmitter.

15. A system comprising:
a controller;
a first radio transceiver, the first radio transceiver associated with a first radio frequency;
a concentrator in communication with the controller, the concentrator comprising:
a memory;
a radio transmitter configured to transmit a radio signal to the first radio transceiver;
a processor in communication with the memory and the radio transmitter, the processor configured to:
request information from the controller;
receive information from the controller in response to the request;
determine a message based on the received information;
generate an audio signal based on the message; and
transmit the audio signal to the radio transmitter.

16. The system of claim 15, further comprising a second radio transceiver, the second radio transceiver associated with a second radio frequency, the second radio frequency different from the first radio frequency; and wherein the processor is further configured to:
select the first radio frequency on the radio transmitter when transmitting to the first transceiver; and
select the second radio frequency on the radio transmitter when transmitting to the second transceiver.

17. The system of claim 15, wherein the processor is further configured to activate the radio transceiver and to deactivate the radio transceiver.

18. A computer-readable medium comprising program code, the program code comprising:
program code for requesting information associated with a status of a machine;
program code for receiving information in response to the request;
program code for determining a message based at least in part on the received information;
program code for generating an audio signal based at least in part on the message; and
program code for transmitting the audio signal to a radio transmitter.

19. The computer-readable medium of claim 18, further comprising program code for generating a textual message and wherein generating the audio signal comprises performing text-to-speech conversion of the textual message.

20. The computer-readable medium of claim 18, further comprising program code for selecting a radio frequency based at least in part on the message.

21. The computer-readable medium of claim 18, further comprising:
program code for activating the radio transmitter before transmitting the audio signal to the radio transmitter, and
program code for deactivating the radio transmitter after transmitting the audio signal to the radio transmitter.
